(19) United States
(12) Patent Application Publication
(10) Pub. No.: US 2026/0152047 A1
(43) Pub. Date: Jun. 4, 2026

(54) AUTOMATIC ANTI-GLARE SYSTEM FOR VEHICLES

(71) Applicant: National Central University, Taoyuan City (TW)

(72) Inventors: Ching-Cherng SUN, Taoyuan City (TW); Zong-Han YANG, Taoyuan City (TW)

(21) Appl. No.: 19/024,809

(22) Filed: Jan. 16, 2025

(30) Foreign Application Priority Data
Dec. 3, 2024 (TW) 113146798

(51) Int. Cl. B60J 3/04; B60J 3/02

(52) U.S. Cl. CPC B60J 3/04; B60J 3/0204

(57) ABSTRACT

An automatic anti-glare system includes a dimming panel installed on a windshield and having multiple independent liquid crystal film zones. A detection unit is electrically connected to the dimming panel and configured to detect glare images of sunlight reaching a driver's eyes. A control unit is electrically connected to the dimming panel and the detection unit. When the detection unit detects glare points in the driver's eyes, the detection unit sends a detection signal to the control unit, and the control unit adjusts a light transmittance of the multiple liquid crystal film zones of the dimming panel based on the detection signal. The automatic anti-glare system gradually dim specific areas of the dimming panel to prevent direct sunlight from causing glare in the driver's eyes, which could affect driving safety.

### BACKGROUND OF THE INVENTION

### 1. Fields of the Invention

The present invention relates to the field of automotive lighting technology, and more particularly, to an automatic anti-glare system for vehicles.

### 2. Descriptions of Related Art

When driving a vehicle, drivers are often exposed to sunlight which obscures their vision, potentially leading to traffic accidents. The current solution mostly involves drivers wearing sunglasses, but the disadvantage of wearing sunglasses is that drivers need to frequently remove and put them on to adapt to changes in sunlight intensity, which can easily distract the driver. Besides wearing sunglasses, the most commonly used method is adjusting the angle of the sun visor to block the sunlight, but the adjustable angle and coverage area of sun visors are quite limited. Therefore, how to solve these shortcomings has become one of the most important issues at present. conventional

The present invention intends to provide an automatic anti-glare system for vehicles to eliminate the shortcomings mentioned above.

### SUMMARY OF THE INVENTION

The present invention relates to an automatic anti-glare system and comprises a dimming panel installed on a windshield and having multiple independent liquid crystal film zones. A detection unit is electrically connected to the dimming panel and configured to detect glare images of sunlight reaching a driver's eyes. A control unit is electrically connected to the dimming panel and the detection unit. When the detection unit detects glare points in the driver's eyes, the detection unit sends a detection signal to the control unit, and the control unit adjusts a light transmittance of the multiple liquid crystal film zones of the dimming panel based on the detection signal.

Preferably, when the control unit is adjusting the light transmittance of each liquid crystal film zone, the detection unit continuously monitors whether the glare points in the driver's eyes have disappeared. When the glare points in the driver's eyes disappear, the direction of the glare is determined, and the control unit dims specific local areas of the liquid crystal film zones on the dimming panel based on the glare direction.

Preferably, the dimming panel is a liquid crystal display.

Preferably, the dimming panel is placed horizontally or vertically.

Preferably, the detection unit is a camera lens with photographing and video recording functions.

The primary object of the present invention is to provide a vehicle automatic anti-glare system to adjust the light transmittance of a dimming panel installed on the windshield based on glare points detected in the driver's eyes. The system gradually dims specific areas of the dimming panel to prevent direct sunlight from causing glare in the driver's eyes, which could affect driving safety.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a schematic diagram of the present invention as used on a car windshield, and

FIG. 2 shows a circuit block diagram of the present invention.

### DETAILED DESCRIPTION OF THE PREFERRED EMBODIMENT

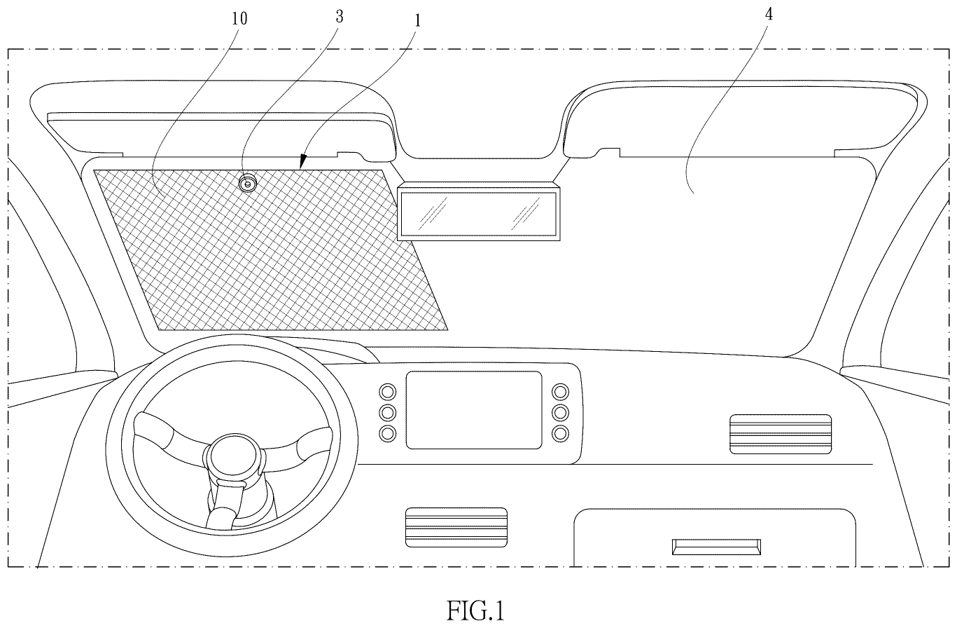

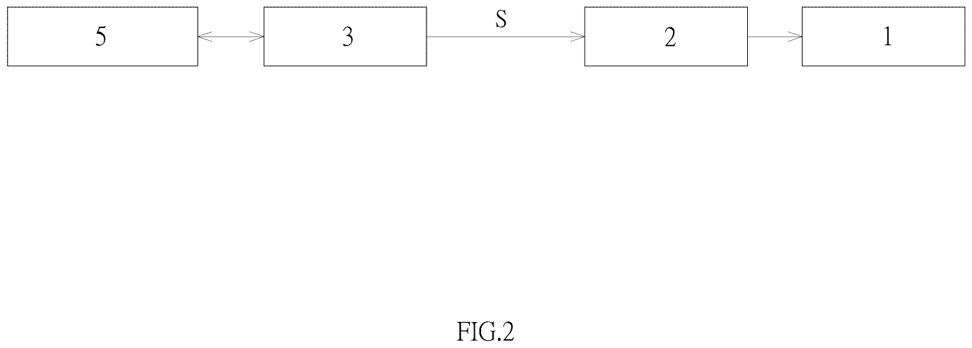

Referring to FIGS. 1 and 2, the automatic anti-glare dimming system of the present invention comprises a dimming panel 1, a control unit 2, and a detection unit 3, which are electrically connected to each other.

The dimming panel 1 is a liquid crystal display, and the liquid crystal film inside the dimming panel 1 is divided into multiple independent liquid crystal film zones 10. In this embodiment, the dimming panel 1 can be installed on the interior side of the car's windshield 4, and the coverage area of the dimming panel 1 can either cover the entire windshield 4 or only cover the windshield 4 in front of the driver. Additionally, the dimming panel 1 can be adjusted to be placed either horizontally or vertically.

The control unit 2 is a controller for the liquid crystal display, with its main function being to receive detection signals “S” from the detection unit 3 and adjust the light transmittance of each liquid crystal film zone 10 of the dimming panel 1.

The detection unit 3 is a camera lens with photographing and video recording functions. In this embodiment, the detection unit 3 can be either mounted on the dimming panel 1 or installed separately, and it is electrically connected to the dimming panel 1 to detect glare images when sunlight hits the driver's eyes 5. The control unit 2 then adjusts the light transmittance of each liquid crystal film zone 10 of the dimming panel 1 based on the detected glare images.

During use, the dimming panel 1 can be placed vertically, at which time all liquid crystal film zones 10 of the dimming panel 1 are in a transparent state, allowing sunlight to pass through the dimming panel 1. The main function of the detection unit 3 is to detect whether bright spots (glare points) appear in the driver's eyes 5 due to sunlight exposure. When the detection unit 3 detects glare points in the driver's eyes 5, it sends a detection signal “S” to the control unit 2. The control unit 2 then adjusts the light transmittance of the multiple liquid crystal film zones 10 of the dimming panel 1 based on the detection signal “S”. During this process, the control unit 2 continuously adjusts the light transmittance of the multiple liquid crystal film zones 10, while the detection unit 3 continuously monitors whether the glare points in the driver's eyes 5 have disappeared. When the detection unit 3 detects that the glare points in the driver's eyes 5 have disappeared, the direction of the glare can be determined. At this point, the control unit 2 dims specific local areas of the multiple liquid crystal film zones 10 on the dimming panel 1 based on the glare direction, preventing direct sunlight from causing glare in the driver's eyes 5 and affecting driving safety.

While we have shown and described the embodiment in accordance with the present invention, it should be clear to those skilled in the art that further embodiments may be made without departing from the scope of the present invention.

What is claimed is:

1. An automatic anti-glare system, comprising:
a dimming panel adapted to be installed on a windshield and having multiple independent liquid crystal film zones;
a detection unit electrically connected to the dimming panel and configured to detect glare images of sunlight reaching a driver's eyes;
a control unit electrically connected to the dimming panel and the detection unit, when the detection unit detects glare points in the driver's eyes, the detection unit sends a detection signal to the control unit, and the control unit adjusts a light transmittance of the multiple liquid crystal film zones of the dimming panel based on the detection signal.

2. The automatic anti-glare system as claimed in claim 1, wherein when the control unit is adjusting the light transmittance of each liquid crystal film zone, the detection unit continuously monitors whether the glare points in the driver's eyes have disappeared, when the glare points in the driver's eyes disappear, the direction of the glare is determined, and the control unit dims specific local areas of the liquid crystal film zones on the dimming panel based on the glare direction.

3. The automatic anti-glare system as claimed in claim 1, wherein the dimming panel is a liquid crystal display.

4. The automatic anti-glare system as claimed in claim 1, wherein the dimming panel is placed horizontally or vertically.

5. The automatic anti-glare system as claimed in claim 1, wherein the detection unit is a camera lens with photographing and video recording functions.
